(19) United States
(12) Patent Application Publication
(10) Pub. No.: US 2007/0173232 A1
(43) Pub. Date: Jul. 26, 2007

(54) Incoming call notification device

(75) Inventors: Ching-Mei Kuo, Taipei (TW); Chang-Chin Lai, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/338,760

(22) Filed: Jan. 25, 2006

(51) Int. Cl. H04Q 7/22

(52) U.S. Cl. 455/412.2

(57) ABSTRACT

An incoming call notification device includes a first connecting unit for the connection with a portable media player; a second connecting device for communicating with the communication device and receiving an incoming call signal; an interrupting module for sending an interruption signal to the portable media player to interrupt the playing content of the portable media player; an incoming call notification storage module for storing at least one notification ring; and a processing module for sending the notification ring to the portable media player to play once the playing content is interrupt, so that the user knows of the incoming call.

### BACKGROUND OF THE INVENTION

1. Field of Invention

The invention relates to an interruption device and, in particular, to an interruption device that interrupts the playing content in response to an incoming call.

2. Related Art

Technological development and environmental changes enable people to have convenient life. Modern electronic products are usually equipped with the features of human operating interface, portability, and multi-functionality. In particular, the mobile phones are undoubtedly the most popular electronic products among all. The growth in the uses can be easily observed from the fact that almost everyone has a mobile phone.

On the other hand, Sony Inc. introduced the first walkman in 1979, starting the era of portable entertainment. With continuous development in music storage and playing devices, the player has evolved from traditional cassettes to compact disk (CD) players, mini disk (MD) players, and MPEG Layer-3 (MP3) players. These portable electronic players have long been favored and used by the public. The prospects of walkmans can be readily seen from the prosperous market and the increasing number of manufacturers in the field.

However, the users of both the mobile phones and the portable electronic players often encounter a problem. That is, when the user wears the head phone of a portable electronic player and enjoys the music, it is difficult for him or her to hear the ring of the mobile phone. Thus, the user may often miss phone calls. Even if the user knows of the incoming call, he or she has to take off the head phone before answering the phone. This is very inconvenient.

### SUMMARY OF THE INVENTION

An object of the invention is to provide an incoming call notification device coupled to a portable media player. After receiving an incoming call signal sent by a communication device, the portable media player interrupts its playing content and transmits a notification ring to the portable media player for playing. The user will not miss phone calls while listening to the music.

To achieve the above object, the incoming call notification device can interrupt the play content of the portable media player when a communication device sends out an incoming call signal. The incoming call notification device includes a first connecting unit, a second connecting unit, an interrupting module, an incoming call notification storage module, and a processing module.

The first connecting unit is coupled to the portable media player. Normally, the portable media player on the market, such as an MP3 player, has a universal serial bus (USB) port. The first connecting unit can thus coupled to the portable media player via this USB port.

The second connecting unit is coupled to the communication device and receives the incoming call signal from it. The second connecting unit can be. coupled to the communication device by a wire or in a wireless means.

The interrupting module sends out an interruption signal to the portable media player once it detects an incoming call signal, thereby interrupting the playing content of the portable media player.

The incoming call notification storage module stores notification rings for incoming calls. The notification rings may be stored in the MP3 format.

The processing module transmits one of the notification rings to the portable media player once the playing content thereof is interrupted, notifying the user of the incoming call.

On the other hand, another incoming call notification device of the invention interrupts the playing content of a portable media player once receiving the incoming call signal of a communication device. The communication device stores at least one notification ring. The incoming call notification device includes a first connecting unit, a second connecting unit, an interrupting module, and a processing module.

The first connecting unit is coupled to the portable media player via, for example, a USB port.

The second connecting unit is coupled to the communication device and receives the incoming call signal from the communication device via a transmission wire or infrared communication.

The interrupting module sends out an interruption signal to the portable media player after detecting an incoming call signal for interrupting the play content of the portable media player.

The processing module is coupled to the second connecting unit, the first connecting unit, and the interrupting module. Once detecting that the playing content of the portable media player is interrupted, it immediately sends a notification ring stored in the communication device to the portable media player for playing, thereby notifying the user of the incoming call.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an incoming call notification device according to the first embodiment of the invention; and

FIG. 2 is an incoming call notification device according to the second embodiment of the invention.

### DETAILED DESCRIPTION OF THE INVENTION

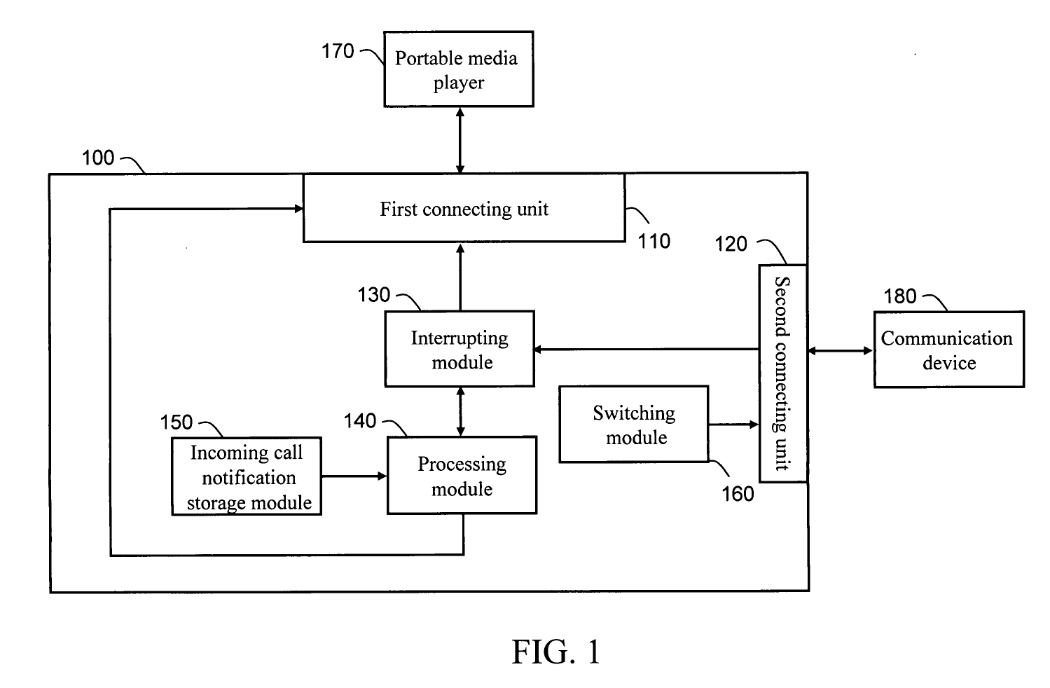

FIG. 1 shows the incoming call notification device according to an embodiment of the invention. When a communication device 180 sends out an incoming call signal, the incoming call notification device interrupts the playing content of a portable media player 170. The incoming call notification device 100 includes at least a first connecting unit 110, a second connecting unit 120, an interrupting module 130, an incoming call notification storage module 150, and a processing module 140.

The first connecting unit 116 is coupled to the portable media player 170. Normally, the portable media player 170, such as an MP3 player, is provided with a USB port. Therefore, the first connecting unit 110 can be a USB port. Thus, the portable media player 170 can be directly connected to the first connecting unit 110.

The second connecting unit 120 is coupled to the communication device 180 and receives an incoming call signal from the communication device 180. The second connecting unit 120 can be a transmission wire connector, and the communication device 180 is a mobile phone. Normally, the mobile phone is provided with a transmission wire connector. Therefore, the second connecting unit 120 and the communication device 180 can be connected by a transmission wire for exchanging messages. Besides, the communication device 180 can be added with an infrared emitter, and the second connecting unit 120 is an infrared receiver. Accordingly, the second connecting unit 120 can receive the incoming call signal sent from the communication device 180 through this wireless transmission.

The interrupting module 130 sends out an interrupting signal to the portable media player 170 once it detects the incoming call signal from the communication device 180, thereby interrupting the playing content of the portable media player 170.

The incoming call notification storage module 150 stores at least one notification ring. The incoming call notification storage module 150 can be a nonvolatile memory. The notification ring is stored in the file format recognizable by the portable media player 170. For example, the portable media player 170 is an MP3 player, and the notification ring is stored in the MP3 format.

The processing module 140, as shown in FIG. 1, is coupled to the incoming call notification storage module 150, the first connecting unit 110, and the interrupting module 130. Once the playing content of the portable media player 170 is interrupted, the notification ring stored in the incoming call notification storage module 150 is immediately transmitted via the first connecting unit 110 to the portable media player 170 for playing. The invention notifies the user of the incoming call in this way.

Besides, the incoming call notification device 100 may further include a switching module 160 coupled to the second connecting unit 120. The user can determine whether to answer the communication device 180.

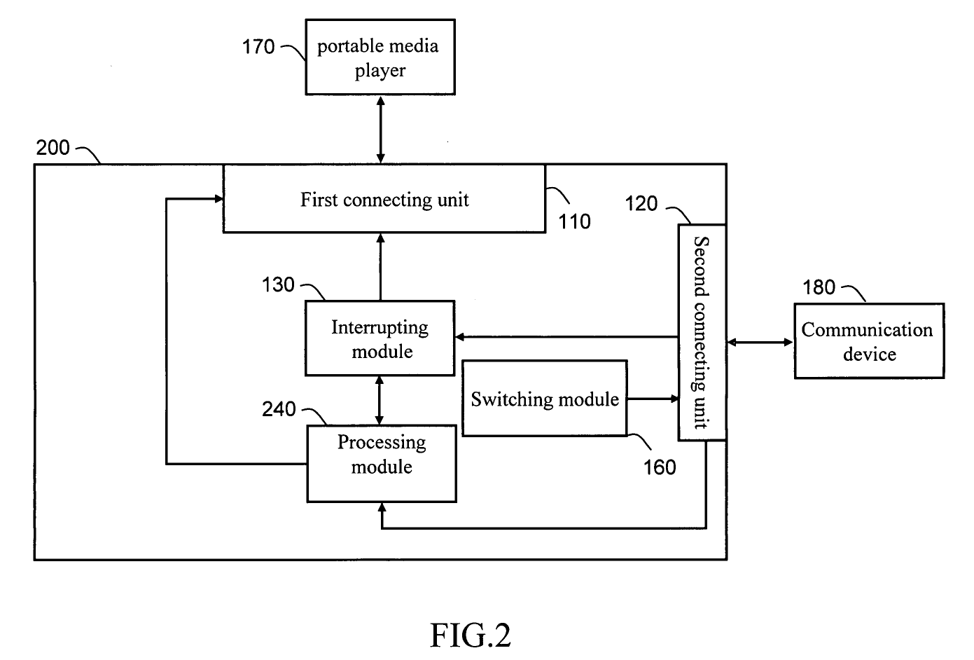

With reference to FIG. 2, the incoming call notification device in another embodiment of the invention interrupts the playing content of the portable media player 170 after receiving the incoming call signal of the communication device 180. The portable media player 170 can be an MP3 player, and the communication device 180 can be a mobile phone. The communication device 180 stores at least one notification ring stored in the file format recognizable by the portable media player 170, such as the MP3 format. The incoming call notification device 200 includes at least a first connecting unit 110, a second connecting unit 120, an interrupting module 130, and a processing module 240.

The first connecting unit 110 is coupled to the portable media player 170. The first connecting unit 110 is a USB port. Since most portable media players 170 have a USB port, the portable media player 170 can be directly inserted into the first connecting unit 110.

The second connecting unit 120 is coupled to the communication device 180 and receives an incoming signal. The second connecting unit 120 can be a transmission wire connector coupled to the communication device 180 with a transmission wire. The second connecting unit 120 may be an infrared receiver to communicate with the communication device 180 equipped with an infrared emitter in a wireless means.

The interrupting module 130 sends an interruption signal to the portable media player 170 after detecting an incoming call signal, thereby interrupting the playing content of the portable media player 170.

The processing module 240 is coupled to the second connecting unit 120, the first connecting unit 110, and the interrupting module 130. When the playing content of the portable media player 170 is interrupted, the processing module 240 sends the notification ring stored in the communication device 180 to the portable media player 170 for notifying the user of the incoming call.

Besides, the incoming call notification device 200 may further include a switching module 160 coupled to the second connecting unit 120 to control whether to answer the incoming call of the communication device 180.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An incoming call notification device for interrupting the playing content of a portable media player when a communication device sends out an incoming call signal, the incoming call notification device comprising:
a first connecting unit, which is coupled to the portable media player;
a second connecting unit, which is coupled to the communication device and receives the incoming call signal;
an interrupting module, which sends out an interruption signal to the portable media player once the incoming call signal is detected, interrupting the playing content of the portable media player;
an incoming call notification storage module, which stores at least a notification ring; and
a processing module, which is coupled to the incoming call notification storage module, the first connecting unit, and the interrupting module for transmitting the notification ring to the portable media player once the playing content thereof is interrupted, thereby notifying the user of an incoming call.

2. The incoming call notification device of claim 1 further comprising a switching module coupled to the second connecting unit for controlling whether to answer the communication device.

3. The incoming call notification device of claim 1, wherein the communication device is a mobile phone.

4. The incoming call notification device of claim 1, wherein the portable media player is an MPEG Layer-3 (MP3) player.

5. The incoming call notification device of claim 1, wherein the first connecting unit is a universal serial bus (USB) port.

6. The incoming call notification device of claim 1, wherein the second connecting unit is a transmission wire connector.

7. The incoming call notification device of claim 1, wherein the second connecting unit is an infrared receiver.

8. The incoming call notification device of claim 1, wherein the incoming call notification storage module is a nonvolatile memory.

9. The incoming call notification device of claim 1, wherein the notification ring is stored in MP3 format.

10. An incoming call notification device for interrupting the playing content of a portable media player when a communication device stored with at least one notification ring sends out an incoming call signal, the incoming call notification device comprising:
a first connecting unit, which is coupled to the portable media player;
a second connecting unit, which is coupled to the communication device and receives the incoming call signal;
an interrupting module, which sends out an interruption signal to the portable media player once the incoming call signal is detected, interrupting the playing content of the portable media player; and
a processing module, which is coupled to the second connecting unit, the first connecting unit, and the interrupting module for transmitting the notification ring to the portable media player once the playing content thereof is interrupted, thereby notifying the user of an incoming call.

11. The incoming call notification device of claim 10 further comprising a switching module coupled to the second connecting unit for controlling whether to answer the communication device.

12. The incoming call notification device of claim 10, wherein the communication device is a mobile phone.

13. The incoming call notification device of claim 10, wherein the portable media player is an MP3 player.

14. The incoming call notification device of claim 10, wherein the first connecting unit is a USB port.

15. The incoming call notification device of claim 10, wherein the second connecting unit is a transmission wire connector.

16. The incoming call notification device of claim 10, wherein the second connecting unit is an infrared receiver.

17. The incoming call notification device of claim 10, wherein the notification ring is stored in MP3 format.
